(19) United States
(12) Patent Application Publication
(10) Pub. No.: US 2025/0187634 A1
(43) Pub. Date: Jun. 12, 2025

(54) SYSTEM AND METHOD FOR TRANSITIONING BETWEEN FEATURE STATES OF A VEHICLE

(71) Applicant: Ford Global Technologies, LLC, Dearborn, MI (US)

(72) Inventors: Krishna Bandi, Novi, MI (US); Syed Amaar Ahmad, Canton, MI (US); Ivan Vukovic, Birmingham, MI (US); Meghna Menon, Ypsilanti, MI (US); Kalpak Kalvit, Milpitas, CA (US)

(73) Assignee: Ford Global Technologies, LLC, Dearborn, MI (US)

(21) Appl. No.: 18/633,069

(22) Filed: Apr. 11, 2024

Related U.S. Application Data
(60) Provisional application No. 63/606,624, filed on Dec. 6, 2023.

(51) Int. Cl. B60W 60/00; B60W 30/182; H04W 4/44

(52) U.S. Cl. CPC B60W 60/0025; B60W 30/182; B60W 2556/65; H04W 4/44

(57) ABSTRACT

A method including the initiation of a state transition from a first state of a plurality of states to a second state of the plurality of states based on a message uniquely associated with the second state, the processing of a handshake protocol associated with the second state in response to the initiation of the state transition from the first state to the second state, and the causation of one or more vehicles to revert to the first state in response to an unsuccessful completion of the handshake protocol associated with the second state.

### CROSS-REFERENCE TO RELATED APPLICATION

This application claims the benefit of and priority to U.S. Provisional Application No. 63/606,624 filed on Dec. 6, 2023, and titled “SYSTEM AND METHOD FOR TRANSITIONING BETWEEN FEATURE STATES OF A VEHICLE”, the contents of which are incorporated herein by reference in its entirety.

### FIELD

The present disclosure relates to an automation process associated with an autonomous vehicle. More specifically, the present disclosure relates to at least the identification and transition between one or more automated vehicle marshaling (AVM) feature states associated with the autonomous vehicle.

### BACKGROUND

The statements in this section merely provide background information related to the present disclosure and may not constitute prior art.

Current standards like the European Telecommunications Standards Institute and the International Organization for do not sufficiently support interoperability within a marshaling environment without utilizing proprietary messages, AVM feature states, and/or backend cloud communications other than a marshaling component. Such an end-to-end design of the marshaling environment can be limiting and complicated to operate as the marshaling environment inherently has proprietary AVM feature states that need to be exchanged with the backend support of the marshaling environment. The present disclosure addresses these and other issues related to the low-speed automation process associated with an autonomous vehicle.

### SUMMARY

This section provides a general summary of the disclosure and is not a comprehensive disclosure of its full scope or all of its features.

The present disclosure provides a method comprising: initiating, at one or more vehicles, a state transition from a first state of a plurality of states to a second state of the plurality of states based on a message uniquely associated with the second state, wherein the message is received from an infrastructure system; processing, by the one or more vehicles, a handshake protocol associated with the second state in response to the initiation of the state transition from the first state to the second state; and causing the one or more vehicles to revert to the first state in response to an unsuccessful completion of the handshake protocol associated with the second state; wherein the plurality of states includes an un-initiated state, a pre-onboarding state, an on-boarding state, a marshaling state, a de-boarding state, and an off-boarding state; wherein an external handshake protocol varies based on each of the plurality of states such that one or more characteristics of the external handshake protocol varies based on each of the plurality of states, and wherein processing the external handshake protocol comprises: initiating one or more actions based on a message exchange between the infrastructure system and the one or more vehicles, wherein the one or more actions includes a verification of a wireless connection associated with the one or more vehicles, an authentication of the message, a validation of whether the one or more vehicles are within an operational design domain, or a combination thereof, and wherein the one or more characteristics of the external handshake protocol includes an inter-transmit time associated with the message, a tolerance threshold of a connection strength associated with the one or more vehicles, or a combination thereof; wherein each state of the plurality of states is associated with a different message; further comprising: causing the one or more vehicles to progress to the second state, from the first state, based on a successful completion of the handshake protocol associated with the second state; further comprising: initiating, at the one or more vehicles, a state transition from the second state of the plurality of states to a third state of the plurality of states based on the progression to the second state and on a message uniquely associated with the third state; processing, by the one or more vehicles, a handshake protocol associated with the third state in response to the initiation of the state transition from the second state to the third state; and causing, the one or more vehicles, to progress to the third state in response to a successful completion of the handshake protocol associated with the third state; and further comprising: transmitting an alert to the infrastructure system associated with the unsuccessful completion of the handshake protocol associated with the second state, wherein the transmission of the alert is based on the reversion of the one or more vehicles to the first state.

The present disclosure provides another method comprising: initiating, at one or more vehicles, a state transition from a first state of a plurality of states to a second state of the plurality of states based on a message uniquely associated with the second state, wherein the message is received from an infrastructure system; processing, by the one or more vehicles, a handshake protocol associated with the second state in response to the initiation of the state transition from the first state to the second state; and causing, the one or more vehicles, to progress to the second state in response to a successful completion of the handshake protocol associated with the second state; wherein the plurality of states includes an un-initiated state, a pre-onboarding state, an on-boarding state, a marshaling state, a de-boarding state, and an off-boarding state; wherein an external handshake protocol varies based on each of the plurality of states such that one or more characteristics of the external handshake protocol varies based on each of the plurality of states, and wherein processing the external handshake protocol comprises: initiating one or more actions based on a message exchange between the infrastructure system and the one or more vehicles, wherein the one or more actions includes a verification of a wireless connection associated with the one or more vehicles, an authentication of the message, a validation of whether the one or more vehicles are within an operational design domain, or a combination thereof, and wherein the one or more characteristics of the external handshake protocol includes an inter-transmit time associated with the message, a tolerance threshold of a connection strength associated with the one or more vehicles, or a combination thereof; wherein each state of the plurality of states is associated with a different message; further comprising: causing the one or more vehicles to revert to the second state, from the first state, based on an unsuccessful completion of the handshake protocol associated with the second state; and further comprising: initiating, at the one or more vehicles, a state transition from the second state of the plurality of states to a third state of the plurality of states based on the progression to the second state and on a message uniquely associated with the third state; processing, by the one or more vehicles, a handshake protocol associated with the third state in response to the initiation of the state transition from the second state to the third state; and causing, the one or more vehicles, to progress to the third state in response to a successful completion of the handshake protocol associated with the third state.

The present disclosure provides a system comprising: a vehicle system associated with one or more vehicles configured to: initiate a state transition from a first state of a plurality of states to a second state of the plurality of states based on a message uniquely associated with the second state, process a handshake protocol associated with the second state in response to the initiation of the state transition from the first state to the second state, and cause the one or more vehicles to revert to the first state in response to an unsuccessful completion of the handshake protocol associated with the second state; and an infrastructure system configured to: send the message to the vehicle system; wherein the plurality of states includes an un-initiated state, a pre-onboarding state, an on-boarding state, a marshaling state, a de-boarding state, and an off-boarding state; wherein an external handshake protocol varies based on each of the plurality of states such that one or more characteristics of the external handshake protocol varies based on each of the plurality of states, and wherein the vehicle system, in association with processing the external handshake protocol, is further configured to: initiate one or more actions based on a message exchange between the infrastructure system and the one or more vehicles, wherein the one or more actions includes a verification of a wireless connection associated with the one or more vehicles, an authentication of the message, a validation of whether the one or more vehicles are within an operational design domain, or a combination thereof, and wherein the one or more characteristics of the external handshake protocol includes an inter-transmit time associated with the message, a tolerance threshold of a connection strength associated with the one or more vehicles, or a combination thereof; wherein each state of the plurality of states is associated with a different message; wherein the vehicle system is further configured to: cause the one or more vehicles to progress to the second state, from the first state, based on a successful completion of the handshake protocol associated with the second state; wherein the vehicle system is further configured to: initiate, at the one or more vehicles, a state transition from the second state of the plurality of states to a third state of the plurality of states based on the progression to the second state and on a message uniquely associated with the third state; process, by the one or more vehicles, a handshake protocol associated with the third state in response to the initiation of the state transition from the second state to the third state; and cause the one or more vehicles to progress to the third state in response to a successful completion of the handshake protocol associated with the third state; and wherein the vehicle system is further configured to: transmit an alert to the infrastructure system associated with the unsuccessful completion of the handshake protocol associated with the second state, wherein the transmission of the alert is based on the reversion of the one or more vehicles to the first state.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a system for autonomous vehicle marshaling in accordance with various implementations;

FIGS. 2A and 2B illustrate a state transition machine in accordance with various implementations;

FIG. 3 is a flowchart illustrating an example method for one or more vehicles to transition between a plurality of AVM feature states in accordance with various implementations; and

FIG. 4 is a flowchart illustrating another example method for one or more vehicles to transition between the plurality of AVM feature states in accordance with various implementations.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure provides a means for utilizing communication between an infrastructure system and one or more autonomous vehicles to support functionality to accommodate one or more AVM feature states associated with any of the autonomous vehicles. For example, the communication may be a message sent by the infrastructure system to any of the autonomous vehicles in relation to the marshaling of the one or more autonomous vehicles (e.g., one or more infrastructure marshaling messages (IMMS)). It is understood that the term “marshaling” can be used interchangeably with the term “maneuvering” in at least the context wherein the one or more autonomous vehicles are under active motion control. As another example, the communication may be a message sent by any of the one or more autonomous vehicles to the infrastructure system regarding an acknowledgement associated with the marshaling of the autonomous vehicles and/or an odometry connection (e.g., one or more vehicle marshaling messages (VMMs)). As an additional example, the one or more AVM feature states may generally include an un-initiated state, an activation state, an operational state, and/or a deactivation state. Additionally, the one or more examples of the present disclosure provide for the ability to handle a variety (e.g., wide range) of different conditions associated with the activation state, the operational state, and/or the deactivation state.

The present disclosure also provides for interoperability between different original equipment manufacturers (OEMs) and suppliers for infrastructure-aided vehicle marshaling use cases including but not limited to: plant marshaling of autonomous vehicles through end-of-line calibration and/or parking; infrastructure-aided valet parking in parking structures; depot marshaling of autonomous vehicles within warehouse depots for service, car wash, etc.; and/or infrastructure-aided hands-free charging of an autonomous vehicle.

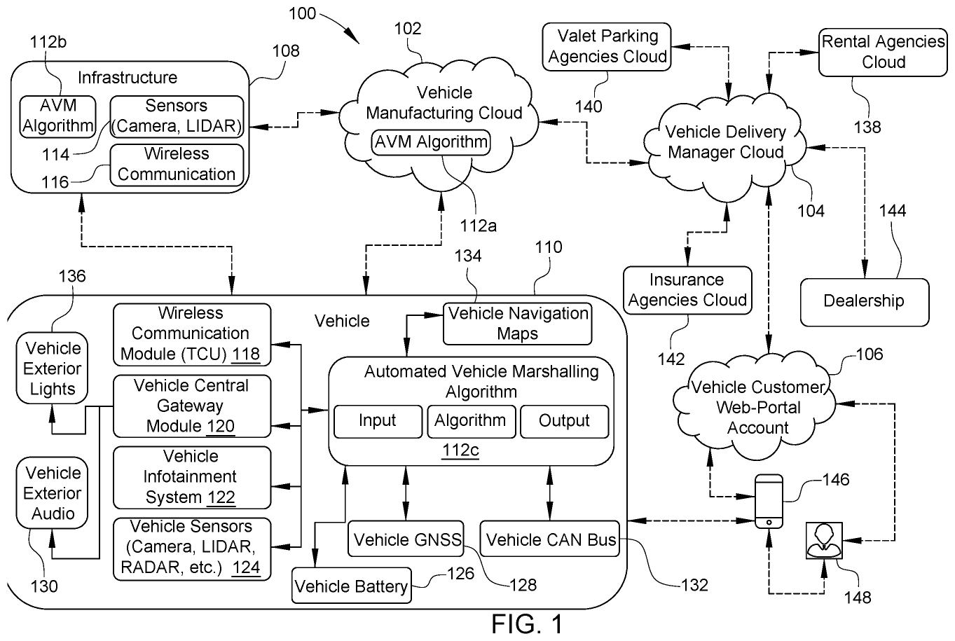

FIG. 1 shows a schematic block diagram illustration of an AVM system 100. The AVM system 100 in one or more examples marshals one or more vehicles traveling at a low speed. However, it is understood that the AVM system 100 may marshal one or more vehicles traveling at any speed. It is also understood that the AVM system 100 may marshal semi-autonomous vehicles and/or fully autonomous vehicles.

The AVM system 100 generally includes a vehicle manufacturing cloud system 102, a vehicle delivery manager cloud system 104, a vehicle customer web-portal account cloud system 106, an infrastructure system 108, and an autonomous vehicle 110. The vehicle manufacturing cloud system 102 operates as the central cloud system that manages and/or facilitates any manufacturing process associated with the autonomous vehicle 110. The vehicle manufacturing cloud system 102 wirelessly communicates with the vehicle delivery manager cloud system 104 and the infrastructure system 108. The vehicle manufacturing cloud system 102 also wirelessly communicates with the autonomous vehicle 110 directly.

The vehicle manufacturing cloud system 102 includes an AVM algorithm 112a. The AVM algorithm 112a processes status information associated with at least the autonomous vehicle 110 of the one or more autonomous vehicles. It is understood that the AVM algorithm 112a processes status information associated with each autonomous vehicle of the one or more autonomous vehicles (e.g., the autonomous vehicle 110). The vehicle manufacturing cloud system 102 is configured to cause the infrastructure system 108 to monitor the progression of the one or more autonomous vehicles (e.g., the autonomous vehicle 110) as the autonomous vehicle(s) progress through a factory floor or parking lot, for example. The vehicle manufacturing cloud system 102 is also configured to cause the infrastructure system 108 to communicate with the one or more autonomous vehicles. For example, the vehicle manufacturing cloud system 102 utilizes the AVM algorithm 112a to send instructions to the infrastructure system 108 and/or to process information received from the infrastructure system 108. The vehicle manufacturing cloud system 102 is configured to cause the vehicle delivery manager cloud system 104 to facilitate a delivery of the one or more autonomous vehicles (e.g., the autonomous vehicle 110) to various locations. For example, the vehicle manufacturing cloud system 102 utilizes the AVM algorithm 112a to send instructions to the vehicle delivery manager cloud system 104 and/or to process information received from the vehicle delivery manager cloud system 104.

The vehicle manufacturing cloud system 102 is also configured to cause the one or more autonomous vehicles to start, stop, or pause progression through a factory floor or parking lot, for example. The vehicle manufacturing cloud system 102 is further configured to control a marshaling speed of the one or more autonomous vehicles as the one or more autonomous vehicles traverse the factory floor or parking lot, for example. In some examples, the vehicle manufacturing cloud system 102 utilizes the AVM algorithm 112a to send instructions to the autonomous vehicle 110 and/or to process information received from the autonomous vehicle 110.

The infrastructure system 108 includes an AVM algorithm 112b, one or more sensors 114, and a sensor component 116. The sensor component 116 provides for communication between one or more infrastructures and the one or more autonomous vehicles. For example, the sensor component 116 may utilize GPS, Wi-Fi, satellite, 3G/4G/5G, and/or Bluetooth™ to communicate with the one or more autonomous vehicles. The sensor component 116 also communicates with the one or more sensors 114, such as, for example, one or more of cameras, lidar, radar, and/or ultrasonic devices. The one or more sensors 114 monitor the movement of the one or more autonomous vehicles as the autonomous vehicle(s) traverse, for example, the factory floor or parking lot. As an example, the infrastructure system 108 utilizes the AVM algorithm 112b to process and send information to the vehicle manufacturing cloud system 102 and/or to process information received from the vehicle manufacturing cloud system 102. As another example, the infrastructure system 108 utilizes the AVM algorithm 112b to process and send information directly to the autonomous vehicle 110 and/or to process information received from the autonomous vehicle 110. It is understood that the infrastructure system 108 can forward instructions received from the vehicle manufacturing cloud system 102 to the autonomous vehicle 110. However, it is also understood that the infrastructure system 108 can send instructions to the autonomous vehicle 110.

The autonomous vehicle 110 includes an AVM algorithm 112c, a wireless transmission module 118, a vehicle central gateway module 120, a vehicle infotainment system 122, one or more vehicle sensors 124, a vehicle battery 126, a vehicle global navigation satellite system (GNSS) 128, vehicle navigation maps 134, vehicle exterior lights 136, vehicle exterior audio 130, and a vehicle CAN bus 132. The wireless transmission module 118 may be a transmission control unit. The wireless transmission module 118 includes one or more sensors that are configured to gather data and send signals to other components of the autonomous vehicle 110. The one or more sensors of the wireless transmission module 118 may include a vehicle speed sensor (not shown) configured to determine a current speed of the autonomous vehicle 110; a wheel speed sensor (not shown) configured to determine if the autonomous vehicle 110 is traveling at an incline or a decline; a throttle position sensor (not shown) determines if a downshift or upshift of one or more gears associated with the autonomous vehicle 110 is required in a current status of the autonomous vehicle 110; and/or a turbine speed sensor (not shown) configured to send data associated with a rotational speed of a torque converter of the autonomous vehicle 110. The wireless transmission module 118 communicates information, gathered by the one or more sensors, to the AVM algorithm 112c. For example, the autonomous vehicle 110 utilizes the AVM algorithm 112c to process and send information gathered by the one or more sensors to the infrastructure system 108. As another example, the autonomous vehicle 110 utilizes the AVM algorithm 112c to process and send information gathered by the one or more sensors to the vehicle manufacturing cloud system 102 directly. The AVM algorithm 112c is configured to communicate information and/or instructions to the wireless transmission module 118 received from the infrastructure system 108 and/or the vehicle manufacturing cloud system 102.

The vehicle central gateway module 120 operates as an interface between various vehicle domain bus systems, such as an engine compartment bus (not shown), an interior bus (not shown), an optical bus for multimedia (not shown), a diagnostic bus for maintenance (not shown), or the vehicle CAN bus 132. The vehicle central gateway module 120 is configured to distribute data communicated to the vehicle central gateway module 120 by each of the various domain bus systems to other components of the autonomous vehicle 110. The vehicle central gateway module 120 is also configured to distribute information received from the AVM algorithm 112c to the various domain bus systems. The vehicle central gateway module 120 is further configured to send information to the AVM algorithm 112c received from the various domain bus systems. For example, the autonomous vehicle 110 utilizes the AVM algorithm 112c to process and send information received from the vehicle central gateway module 120 to the infrastructure system 108. As another example, the autonomous vehicle 110 utilizes the AVM algorithm 112c to process and send information received from the vehicle central gateway module 120 to the vehicle manufacturing cloud system 102 directly. The AVM algorithm 112c is configured to communicate information and/or instructions to the vehicle central gateway module 120 received from the infrastructure system 108 and/or the vehicle manufacturing cloud system 102.

The vehicle infotainment system 122 is a system that delivers a combination of information and entertainment content and/or services to an operator 148 of the autonomous vehicle 110. It is understood that the vehicle infotainment system 122 can deliver entertainment content to the operator 148 of the autonomous vehicle 110, in some examples. It is also understood that the vehicle infotainment system 122 can deliver information services to the operator 148 of the autonomous vehicle 110, in some examples. In one or more examples, the vehicle infotainment system 122 includes built-in car computers that combine one or more functions, such as digital radios, built-in cameras, and/or televisions. The vehicle infotainment system 122 communicates information associated with the built-in car computers or processors to the AVM algorithm 112c. For example, the autonomous vehicle 110 utilizes the AVM algorithm 112c to process and send information received from the vehicle infotainment system 122 to the infrastructure system 108. As another example, the autonomous vehicle 110 utilizes the AVM algorithm 112c to process and send information received from the vehicle infotainment system 122 to the vehicle manufacturing cloud system 102 directly. The AVM algorithm 112c is configured to communicate information and/or instructions to the vehicle infotainment system 122 received from the infrastructure system 108 and/or the vehicle manufacturing cloud system 102.

The one or more vehicle sensors 124 may be, for example, one or more of cameras, lidar, radar, and/or ultrasonic devices. For example, ultrasonic devices utilized as the one or more vehicle sensors 124 emit a high frequency sound wave that hits an object (e.g., a wall or another vehicle) and is then reflected back to the autonomous vehicle 110. Based on the amount of time it takes for the sound wave to return to the autonomous vehicle 110, the autonomous vehicle 110 can determine the distance between the one or more vehicle sensors 124 and the object. As another example, camera devices utilized as the one or more vehicle sensors 124 provide a visual indication of a space around the autonomous vehicle 110. As an additional example, radar devices utilized as the one or more vehicle sensors 124 emit electromagnetic wave signals that hit the object and is then reflected back to the autonomous vehicle 110. Based on the amount of time it takes for the electromagnetic waves to return to the autonomous vehicle 110, the autonomous vehicle 110 can determine a range, velocity, and angle of the autonomous vehicle 110 relative to the object.

The one or more vehicle sensors 124 communicate information associated with the position and/or distance at which the autonomous vehicle 110 is relative to the object to the AVM algorithm 112c. For example, the vehicle 110 utilizes the AVM algorithm 112c to process and send information received from the one or more vehicle sensors 124 to the infrastructure system 108. As another example, the autonomous vehicle 110 utilizes the AVM algorithm 112c to process and send information received from the one or more vehicle sensors 124 to the vehicle manufacturing cloud system 102 directly. The AVM algorithm 112c is configured to communicate information and/or instructions to the one or more vehicle sensors 124 received from the infrastructure system 108 and/or the vehicle manufacturing cloud system 102.

The vehicle battery 126 is controlled by a battery management system (not shown) that provides instructions to the vehicle battery 126. For example, the battery management system provides instructions to the vehicle battery 126 based on a temperature of the vehicle battery 126. The battery management system ensures acceptable current modes of the vehicle battery 126. For example, the acceptable current modes protect against overvoltage, overcharge, and/or overheating of the vehicle battery 126. As another example, the temperature of the vehicle battery 126 indicates to the battery management system whether any of the acceptable current modes are within acceptable temperate ranges. The battery management system associated with the vehicle battery 126 communicates information associated with the temperature of the vehicle battery 126 to the AVM algorithm 112c. For example, the autonomous vehicle 110 utilizes the AVM algorithm 112c to process and send information received regarding the vehicle battery 126 to the infrastructure system 108. As another example, the autonomous vehicle 110 utilizes the AVM algorithm 112c to process and send information regarding the vehicle battery 126 to the vehicle manufacturing cloud system 102 directly. The AVM algorithm 112c is configured to communicate information and/or instructions to the vehicle battery 126 received from the infrastructure system 108 and/or the vehicle manufacturing cloud system 102.

The vehicle GNSS 128 is configured to communicate with satellites so that the autonomous vehicle 110 can determine a specific location of the autonomous vehicle 110. The vehicle navigation maps 134 can display, via a display screen (not shown), the specific location of the autonomous vehicle 110 to the operator 148. The vehicle GNSS 128 communicates geographical information associated with the autonomous vehicle 110 to the AVM algorithm 112c. For example, the autonomous vehicle 110 utilizes the AVM algorithm 112c to process and send information received from the vehicle GNSS 128 to the infrastructure system 108. As another example, the autonomous vehicle 110 utilizes the AVM algorithm 112c to process and send information from the vehicle GNSS 128 to the vehicle manufacturing cloud system 102 directly. The AVM algorithm 112c is configured to communicate information and/or instructions to the vehicle GNSS 128 received from the infrastructure system 108 and/or the vehicle manufacturing cloud system 102. As another example, the autonomous vehicle 110 utilizes the AVM algorithm 112c to process and send information associated with the vehicle navigation maps 134 to the infrastructure system 108. As another example, the autonomous vehicle 110 utilizes the AVM algorithm 112c to process and send information from the vehicle navigation maps 134 to the vehicle manufacturing cloud system 102 directly. The AVM algorithm 112c is configured to communicate information and/or instructions to the vehicle navigation maps 134 received from the infrastructure system 108 and/or the vehicle manufacturing cloud system 102.

The vehicle exterior lights 136 can include one or more lights that are embedded around a perimeter of the autonomous vehicle 110. For example, the vehicle exterior lights 136 include, but are not limited to, low-beam headlamps, high-beam headlamps, park lights, daytime running lights, fog lights, signal lights, side marker lights, cab lights, taillights, rear-end lights, and/or reverse lights. The vehicle exterior lights 136 are configured to turn ON and OFF automatically based on an exterior weather condition. The vehicle exterior lights 136 are also configured to turn ON and OFF automatically based on brightness of a light adjacent to the autonomous vehicle 110, such as sunlight, artificial light, and/or an absence of light and/or a reduction in the light. The vehicle exterior lights 136 are further configured to turn ON and OFF manually by the operator 148. Additionally, the vehicle exterior lights 136 are configured to turn ON and OFF in a pattern to provide visual notification or information, such as indicative of one or more faults. For example, the one or more faults include an error associated with a pre-onboarding status, an onboarding status, an AVM feature activation, a vehicle key detection, a blinking sequence, a vehicle GNSS time synchronization, an onboarding readiness check, vehicle security certifications, an offboarding status, a wireless connection between the autonomous vehicle 110 and a roadside unit (RSU), a wireless connection between the autonomous vehicle 110 and the infrastructure system 108, a cellular signal of a marshaling status; an enablement of a CV2X-PC5 congestion state; an expiration of one or more vehicle security certifications; an occurrence of a latency delay between wireless messages; and a disrupted wireless connection of the one or more autonomous vehicles 110 with a server. The autonomous vehicle 110 communicates one or more instructions to the vehicle exterior lights 136 based on the AVM algorithm 112c. For example, the autonomous vehicle 110 communicates one or more instructions received from the infrastructure system 108 to the vehicle exterior lights 136. As another example, the autonomous vehicle 110 communicates one or more instructions received directly from the vehicle manufacturing cloud system 102 to the vehicle exterior lights 136.

The vehicle exterior audio 130 can include a horn of the autonomous vehicle 110 that is configured to sound upon the manual operation by the operator 148. The vehicle exterior audio 130 is also configured to sound ON and OFF in a pattern to provide audible notification of information, such as indicative of the one or more faults. For example, the one or more faults include a an error associated with a pre-onboarding status, an onboarding status, an AVM feature activation, a vehicle key detection, a honking sequence, a vehicle GNSS time synchronization, an onboarding readiness check, vehicle security certifications, an offboarding status, a wireless connection between the autonomous vehicle 110 and a roadside unit (RSU), a wireless connection between the autonomous vehicle 110 and the infrastructure system 108, a cellular signal of a marshaling status; an enablement of a CV2X-PC5 congestion state; an expiration of one or more vehicle security certifications; an occurrence of a latency delay between wireless messages; and a disrupted wireless connection of the one or more autonomous vehicles 110 with a server. The autonomous vehicle 110 communicates one or more instructions to the vehicle exterior audio 130 based on the AVM algorithm 112c. For example, the autonomous vehicle 110 communicates one or more instructions received from the infrastructure system 108 to the vehicle exterior audio 130. As another example, the autonomous vehicle 110 communicates one or more instructions received directly from the vehicle manufacturing cloud system 102 to the vehicle exterior audio 130.

The delivery manager cloud system 104 wirelessly communicates (e.g., receives and/or sends instructions and/or information) with one or more of a rental agencies cloud system 138, a valet parking agencies cloud system 140, an insurance agencies cloud system 142, and/or a dealership 144. For example, the delivery manager cloud system 104 can facilitate the delivery of the one or more autonomous vehicles to any of the rental agencies cloud system 138, the valet parking agencies cloud system 140, the insurance agencies cloud system 142, and/or the dealership 144. The delivery manager cloud system 104 also wirelessly communicates with the vehicle customer web-portal account cloud system 106. It should be understood that other cloud systems can be included in one or more examples.

The delivery manager cloud system 104 wirelessly communicates with a user device 146 such as a mobile device, a display panel, and/or a computer. The autonomous vehicle 110 also wirelessly communicates directly with the user device 146. For example, the operator 148 engages with the user device 146 via an application that organizes any information and/or instructions received from the vehicle customer web-portal account cloud system 106 and/or the autonomous vehicle 110. As another example, the operator 148 may send one or more instructions to the vehicle customer web-portal account cloud system 106 such as making a selection of which vehicle the operator 148 would like to receive from any of a rental agency (not shown) associated with the rental agencies cloud system 138, a valet parking agency (not shown) associated with the valet parking agencies cloud system 140, an insurance agency (not shown) associated with the insurance agencies cloud system 142, and/or the dealership 144.

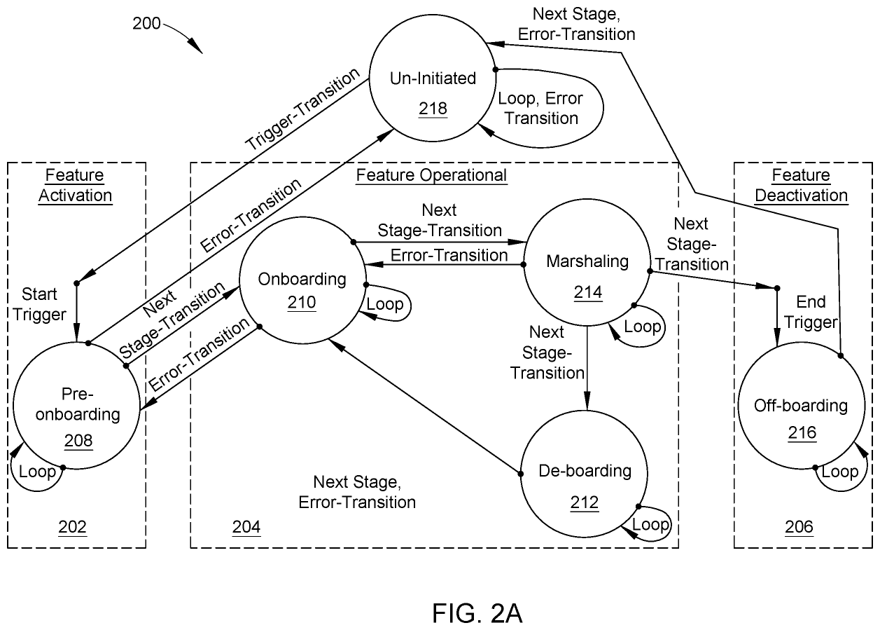

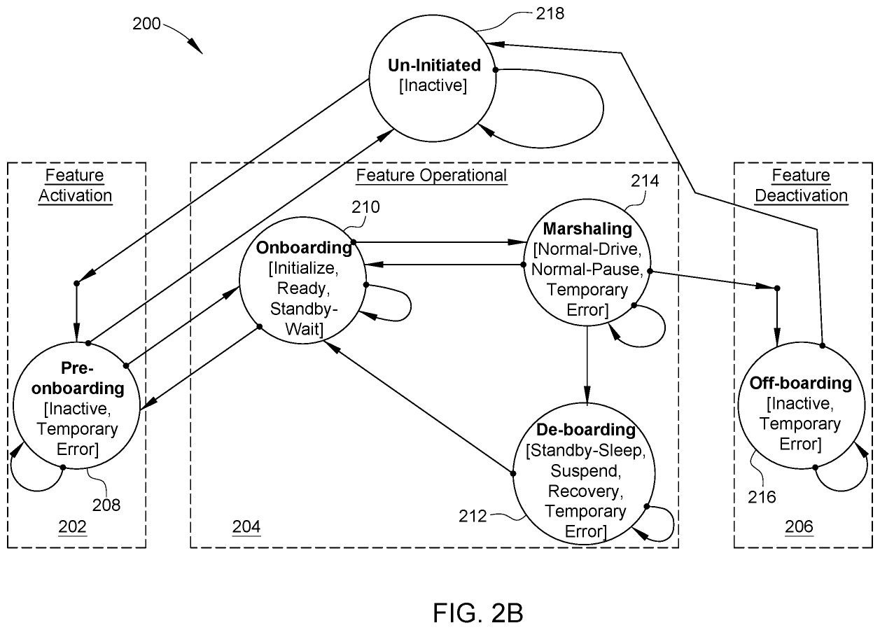

FIGS. 2A and 2B depict a schematic illustration of a state transition machine (e.g., a state processing device) and pathways 200 showing the AVM feature state identification and transition between such AVM feature states. The state transition machine generally includes a feature activation stage 202, a feature operational stage 204, and a feature deactivation stage 206. A pre-onboarding state 208 is included as a part of the feature activation stage 202. The feature operational 204 stage includes an on-boarding state 210, a de-boarding state 212, and a marshaling state 214. An off-boarding state 216 is included as a part of the feature deactivation stage 206. Additionally, an un-initiated state 218 is not included in any of the feature activation stage 202, the feature operational state 204, or the feature deactivation stage 206.

It is understood that any additional state can be added to the state transition machine 200 and any of the states of the plurality of states can be removed from the state transition machine 200. It is further understood that the nomenclature associated with each of the states of the plurality of states (e.g., the pre-onboarding state 208, the on-boarding state 210, the de-boarding state 212, the marshaling state 214, the off-boarding state 218, and the un-initiated state 218) are descriptive in nature, wherein any of the states of the plurality of states can be referred to by any other term. It is additionally understood that, generally, within the state transition machine 200 motion control (e.g., state transition control) can occur between the plurality of states to configure and validate that the subsystems associated with the state transition machine 200 are operating properly, sufficiently authenticated, and are prepared to proceed to the next state or towards successful termination of the communication session.

Generally, and as will be described in further detail below, the state transition machine 200 is associated with each AVM facility infrastructure (e.g., the infrastructure system 108) and/or each autonomous vehicle (e.g., the autonomous vehicle 110). Furthermore, every time there is an error in operation of the state transition machine 200, the current AVM feature state reverts to the prior AVM feature state. Additionally, each AVM feature state included in the state transition machine 200 is maintained by an infrastructure system and autonomous vehicle pairing. Moreover, a wireless handshaking protocol (e.g., inter-transmit time, message flow, etc.) may differ in each AVM feature state through the utilization of two messages (e.g., the IIM and VMM messages). For example, as depicted in FIGS. 2A and 2B, the handshake protocol can include a loop process associated with each feature state.

More specifically, the un-initiated state 218 is a default state in which an automated vehicle system associated with each of the one or more autonomous vehicle(s) 110 and the infrastructure system 108 are both in an in-active state for a respective autonomous vehicle 110. However, it is understood that the automated vehicle system associated with each of the one or more autonomous vehicle(s) 110 and the infrastructure system 108 can both be in an in-active state for each of the autonomous vehicle(s) 110. The pre-onboarding state 208 is a state in which the infrastructure system 108 and the autonomous vehicle 110 perform an activation process for respective automated vehicle marshaling (AVM) feature(s). The on-boarding state 210 is a state that when the infrastructure system 108 and the autonomous vehicle 110 complete necessary authorization activities as part of a vehicle identification process (e.g., a blinking code sequence), the infrastructure system 108 can gain control of the respective autonomous vehicle(s) 110 prior to the infrastructure system 108 taking control of the autonomous vehicle 110 and the start of marshaling the respective autonomous vehicle(s) 110.

The marshaling state 214 is a state where the infrastructure system 108 controls the autonomous vehicle 110 so that the infrastructure system 108 can autonomously marshal the autonomous vehicle 110 to perform certain actions while the autonomous vehicle 110 transmits an acknowledgement back to the infrastructure system 108 associated with the marshaling process via both a high data rate and a low data rate associated with a wireless communication(s). The marshaling state 214 can also provide for the disengagement of the autonomous vehicle 110 from the infrastructure system 108 due to certain actions for certain periods of time while the autonomous vehicle 110 is stationary and not being actively marshaled (e.g., a keep-alive state). The de-boarding state 212 is a state in which the autonomous vehicle 110 performs a temporary off-boarding process from current active marshaling of the autonomous vehicle 110 based on instructions from the infrastructure system 108 (e.g., not keeping-alive state) and/or human intervention. It is understood that the performance of the temporary off-boarding process can also be based on the autonomous vehicle 110 leaving an AVM geo-fenced operational design domain (ODD) for a certain activity, the autonomous vehicle 110 being asked to power-cycle, or any other instruction-based action that the autonomous vehicle 110 may be caused to perform, for example. As an example, once the autonomous vehicle 110 switches into the de-boarding state, the wireless communication(s) between the autonomous vehicle 110 and the infrastructure system 108 stops. The off-boarding state 218 is a state in which the infrastructure system 108 and the autonomous vehicle 110 perform a deactivation process for the respective AVM feature(s). For example, the autonomous vehicle 110 will undergo the deactivation process at an end-destination and, in this case, the infrastructure system 108 will no longer control the autonomous vehicle 110 from a respective ODD area. For example, the off-boarding state 216 is activated when the autonomous vehicle 110 completes de-authorization activities with the AVM server and ceases marshaling.

In some examples, each state of the plurality of states is associated with a different input. For example, and as is discussed above, the input is included within a handshake protocol unique to each state of the plurality of states. In other words, each state of the plurality of states can correspond to a different handshake protocol. The input associated with the un-initiated state 218 comprises the receipt of a trigger from the infrastructure system 108 by the respective autonomous vehicle(s) 110. For example, the trigger can be a request for the respective autonomous vehicle(s) 110 to be added to an AVM geo-fenced ODD. The input associated with the pre-onboarding state 208 comprises the instance wherein the infrastructure system 108 transitions to the pre-onboarding state 208. For example, when the infrastructure system 108 transitions to the pre-onboarding state 208 the infrastructure system 108 sends a IMM to the autonomous vehicle(s) 110 to initiate the pre-onboarding process. As another example, the autonomous vehicle(s) 110 acknowledges the IMM received from the infrastructure system 108 by sending a VMM to the infrastructure system 108.

The input associated with the on-boarding state 210 in some examples comprises the instance wherein the infrastructure system 108 transitions to the on-boarding state 210. For example, when the infrastructure system 108 transitions to the on-boarding state 210 the infrastructure system 108 sends a IMM to the autonomous vehicle(s) 110 to initiate the onboarding process. As another example, the autonomous vehicle(s) 110 acknowledges the IMM received from the infrastructure system 108 by sending a VMM to the infrastructure system 108 when both the infrastructure system 108 and the autonomous vehicle 110 have successfully completed a handshake protocol associated with the pre-onboarding state 208 and have transitioned via a next state transition step associated with the pre-onboarding state 208.

The input associated with the marshaling state 214, in some examples, comprises the instance wherein the infrastructure system 108 transitions to the marshaling state 214. For example, when the infrastructure system 108 transitions to the marshaling state 214 the infrastructure system 108 sends a IMM to the autonomous vehicle(s) 110 to initiate the marshaling process. As another example, the autonomous vehicle(s) 110 acknowledges the IMM received from the infrastructure system 108 by sending a VMM to the infrastructure system 108 when both the infrastructure system 108 and the autonomous vehicle(s) 110 have successfully completed a handshake protocol associated with the on-boarding state 210 and have transitioned via a next state transition step associated with the on-boarding state 210. As yet another example, the infrastructure system 108 can trigger the autonomous vehicle(s) to transition from the marshaling state 214 to another state of the plurality of states to maintain a keep-alive state.

The input associated with the de-boarding state 212 in some examples comprises the instance wherein the infrastructure system 108 transitions to the de-boarding state 212. For example, when the infrastructure system 108 transitions to the de-boarding state 212 the infrastructure system 108 sends a IMM to the autonomous vehicle(s) 110 to initiate the de-boarding process. As another example, the autonomous vehicle(s) 110 acknowledges the IMM received from the infrastructure system 108 by sending a VMM to the infrastructure system 108 when both the infrastructure system 108 and the autonomous vehicle(s) 110 have successfully completed a handshake protocol associated with the marshaling state 214 and have transitioned via a next state transition step associated with the marshaling state 214. The input associated with the off-boarding state 218 comprises the instance wherein the infrastructure system 108 transitions to the off-boarding state 218. For example, when the infrastructure system 108 transitions to the off-boarding state 218 the infrastructure system 108 sends a IMM to the autonomous vehicle(s) 110 to initiate the off-boarding process. As another example, the autonomous vehicle(s) 110 acknowledges the IMM received from the infrastructure system 108 by sending a VMM to the infrastructure system 108 when both the infrastructure system 108 and the autonomous vehicle(s) 110 have successfully completed a handshake protocol associated with the marshaling state 214 and have transitioned via a next state transition step associated with the marshaling state 214.

The handshake protocol (e.g., the loop-process) associated with the un-initiated state 218 comprises the infrastructure system 108 exchanging information with the autonomous vehicle(s) 110. As a non-limiting example, the information can include configuration and/or recognition parameters for the autonomous vehicles 110. However, it is understood that the information may pertain to any information associated with the autonomous vehicle(s) 110. The handshake protocol associated with the un-initiated state 218 further comprises a verification of whether the infrastructure system 108 and/or the autonomous vehicle(s) 110 have a particular software installed on their respective systems.

The handshake protocol associated with the pre-onboarding state 208, in some examples, comprises the completion of wireless communication interface checks between the autonomous vehicle(s) 110 and the infrastructure system 108. The handshake protocol associated with the pre-onboarding state 208 further comprises the completion of security certification checks on both the autonomous vehicle(s) 110 and the infrastructure system 108 needed for the wireless communication interface. The handshake protocol associated with the pre-onboarding state 208 also comprises the completion of a check-in sequence on the autonomous vehicle(s) 110 and the infrastructure system 108. For example, the check-in sequence includes the completion of autonomous vehicle state and/or fault checks. As another example, the check-in sequence also includes the completion of infrastructure state and/or fault checks for respective autonomous vehicle(s) 110 are completed. The handshake protocol associated with the pre-onboarding state 208 additionally comprises the exchange of a vehicle identifier that is used by both the autonomous vehicle(s) 110 and the infrastructure system 108.

The handshake protocol associated with the on-boarding state 210, in some examples, comprises the completion of the blinking code sequence. In other words, an autonomous vehicle identification authorization utilized to take control of the respective autonomous vehicle(s) 110 is completed by the infrastructure system 108 when the autonomous vehicle(s) 110 is in a designated drop-off area by exchanging IMMs and/or VMMs (e.g., between the infrastructure system 108 and the autonomous vehicle(s) 110). For example, the blinking code sequence includes the completion of a handover sequence. As another example, the blinking code sequence also includes the completion of a mission assignment sequence. The handshake protocol associated with the on-boarding state 210 further comprises an instance wherein the autonomous vehicle(s) 110 informs the infrastructure system 108 (e.g., via VMMs) about the autonomous vehicle(s) 110 and/or if the infrastructure system 108 is able to identify and/or detect the autonomous vehicle(s) 110 and sends a request (e.g., via a IMMs) to the autonomous vehicle 110 for confirmation. For example, the autonomous vehicle(s) 110 can send confirmation of the request received from the infrastructure system 108 via VMMs. As another example, the confirmation may also be associated with information regarding: whether the autonomous vehicle doors and/or windows are locked (e.g., when the autonomous vehicle 110 is in a stationary position); locations where there are no humans and/or animals in the autonomous vehicle(s) 110; vehicle properties associated with the autonomous vehicle(s) 110; whether there is any human intervention associated with the autonomous vehicle 110; whether a destination and/or route sequence is complete; or a combination thereof.

The handshake protocol associated with the marshaling state 214, in some examples, comprises an instance wherein the infrastructure system 108 has control over a respective autonomous vehicle 110 and instructs the autonomous vehicle(s) 110 to drive, pause, and/or marshal states from a first point (e.g., station-1/point-A) to a second point (e.g., station-2/point-B) and so-on via IMMs and/or VMMs at a high data rate. For example, the infrastructure system 108 instructs the autonomous vehicle(s) 110 to transition from driving to a pause when an obstacle is blocking the path of the autonomous vehicle 110 and/or when the autonomous vehicle(s) 110 approaches a facility-defined stop location (e.g., an intersection). As another example, the infrastructure system 108 instructs the autonomous vehicle 110 to transition from a pause to drive when obstacles previously blocking the path of the autonomous vehicle 110 no longer exist and/or when the intersection is clear to proceed. As an additional example, the infrastructure system 108 is able to communicate (e.g., in the instance wherein the infrastructure system 108 has control over respective autonomous vehicle(s) 110) with the autonomous vehicle(s) 110 via IMMs and/or VMMs over a low-data-rate (e.g., the exchange of IMMs and/or VMMs per 1 second or 2 second intervals). The handshake protocol associated with the marshaling state 214 also comprises the instance wherein a human intervenes during the marshaling state 214, at which point the VMMs are sent at a higher-data-rate while the autonomous vehicle(s) 110 is still in the marshaling state 212.

The handshake protocol associated with the de-boarding state 212, in some examples, comprises the instance wherein the autonomous vehicle(s) 110 performs actions such as an ignition-OFF action as instructed by the infrastructure system 108 (e.g., via a IMM) when the autonomous vehicle(s) 110 is in an AVM area. However, it is understood that the de-boarding state 212 comprises the instance wherein the autonomous vehicle(s) 110 performs actions such as an ignition-OFF action as instructed by the infrastructure system 108 (e.g., via a IMM) when the autonomous vehicle 110 is not in the AVM area or exiting the AVM area. For example, the de-boarding state 212 varies based on a use-case wherein the autonomous vehicle(s) 110 leaves the geo-fenced ODD zone to perform the autonomous vehicle's 110 various actions. The handshake protocol associated with the de-boarding state 212 also comprises the instance wherein the autonomous vehicle(s) 110 informs the infrastructure system 108 (e.g., via VMMs) about the autonomous vehicle(s) 110 and/or if the infrastructure system 108 is able to identify and/or detect the autonomous vehicle(s) 110 and sends a request (e.g., via IMMs) to the autonomous vehicle(s) 110 for confirmation. For example, the autonomous vehicle(s) 110 can send confirmation of the request received from the infrastructure system 108 via VMMs. As another example, the confirmation may also be associated with information regarding whether there is any human intervention associated with the autonomous vehicle(s) 110 and/or temporary off-boarding (e.g., a disruption in connectivity between the infrastructure system 108 and the autonomous vehicle(s) 110). The handshake protocol associated with the de-boarding state 212 state further comprises the instance wherein there is no keep-alive wireless communication present (e.g., no IMM-VMM communications are exchanged between the infrastructure system 108 and the autonomous vehicle(s) 110). For example, after the instance wherein the infrastructure system 108 and the autonomous vehicle(s) 110 have transitioned into the de-boarding state 212, it is understood that after certain messages are exchanged, the infrastructure system 108 will not have control of the autonomous vehicle(s) 110. As another example, after the instance wherein the infrastructure system 108 and the autonomous vehicle(s) 110 have transitioned into the de-boarding state, 214 the infrastructure system 108 records the respective autonomous vehicle(s) 110 state in an infrastructure database (not shown).

The handshake protocol associated with the off-boarding state 218, in some examples, comprises the instance wherein the check-out sequence on the autonomous vehicle(s) 110 and/or the infrastructure system 108 is completed (i.e., wherein the check-out sequence on the autonomous vehicle(s) 110 and/or the infrastructure system 108 is triggered). The handshake protocol associated with the off-boarding state 218 also comprises the instance wherein the infrastructure system 108 revokes system authority for the autonomous vehicle(s) 110.

As another example, a successful completion of the handshake protocol, in some examples, is indicated by the next state transition step. As a further example, the unsuccessful completion of the handshake protocol, in some examples, is indicated by an error state transition step.

Each state of the plurality of states is associated with a different output. For example, the output is included within the handshake protocol unique to each state of the plurality of states. As another example, the output itself can include any of the next state transition steps and/or the error state transition step. The next state transition step of the un-initiated state 218 comprises an instance wherein the infrastructure system 108 sends a trigger transitional message to the respective autonomous vehicle(s) 110 to transition to the pre-onboarding state 208. The next state transition step of the un-initiated state 218 also comprises an instance wherein the infrastructure system 108 switches the state handling for the respective autonomous vehicle(s) 110 to the pre-onboarding state 208. The error state transition step of the un-initiated state 218 comprises an instance wherein the infrastructure system 108 informs an automated vehicle cloud backend and/or system operator of the error state occurrence associated with the infrastructure system 108 and/or the automated vehicle(s) 110. For example, the error state includes, but is not limited to, an insufficient autonomous vehicle configuration, recognition parameters, or a combination thereof.

The next state transition step of the pre-onboarding state 208, in some examples, comprises an instance wherein the infrastructure system 108 sends a trigger transitional message to the respective vehicle(s) 110 to initiate a start trigger action associated with the on-boarding state 210. The next state transition step of the pre-onboarding state 208 also comprises an instance wherein the infrastructure system 108 switches the state handling for the respective autonomous vehicle(s) 110 to the on-boarding state 210 (e.g., via IMM and/or VMM exchanges when the handshake protocol associated with the pre-onboarding state 208 is completed). The error state transition step of the pre-onboarding state 208 comprises an instance wherein the infrastructure system 108 is unable to complete the handshake protocol associated with the pre-onboarding state 208. The error state transition step of the pre-onboarding state 208 also comprises an instance wherein the autonomous vehicle(s) 110 are unable to complete the pre-onboarding process. In both instances of the error state transition step, the infrastructure system 108 and/or the autonomous vehicle(s) 110 informs the system operator and/or the cloud backend and causes the infrastructure system 108 and the autonomous vehicle(s) 110 to transition back to the un-initiated state 218.

The next state transition step of the on-boarding state 210, in some examples, comprises an instance wherein the infrastructure system 108 sends a trigger transitional message to the respective autonomous vehicle(s) 110 to initiate a start trigger associated with the marshaling state 214. The next state transition state of the on-boarding state 210 also comprises an instance wherein the infrastructure system 108 switches the state handling for the respective autonomous vehicle(s) 110 to the marshaling state 214 when the handshake protocol associated with the on-boarding state 210 is completed. The error state transition step of the on-boarding state 210 comprises an instance wherein the infrastructure system 108 sends a trigger transitional message to the respective autonomous vehicle(s) 110 to initiate a start trigger back to the pre-onboarding state 208. The error state transition state of the on-boarding state 210 also comprises an instance wherein the infrastructure system 108 switches the state handling for the respective autonomous vehicle(s) 110 to the pre-onboarding state 208 when there is an error associated with the blinking code handover sequence and/or when the completion of the mission accomplished sequence is interrupted. The error state transition step of the on-boarding state 210 further comprises an instance wherein the infrastructure system 108 switches the state handling for the respective autonomous vehicle(s) 110 to the pre-onboarding state 208 when the autonomous vehicle(s) 110 informs the infrastructure system 108 (e.g., via VMMs) about the autonomous vehicle(s) 110 regarding: whether there is any human intervention on the autonomous vehicle 110; whether there are any humans and/or animals in the autonomous vehicle 110; whether the doors and/or windows are not locked; or a combination thereof.

The next state transition step of the marshaling state 214, in some examples, comprises an instance wherein the infrastructure system 108 sends a trigger transitional message to the respective vehicle(s) 110 to initiate a start trigger associated with the de-boarding state 212. The next state transition step of the marshaling state 214 also comprises an instance wherein the infrastructure system 108 switches the state handling for the respective autonomous vehicle(s) 110 to the de-boarding state 212. For example, IMMs and VMMs are exchanged between the infrastructure system 108 and the autonomous vehicle(s) 110 in the instance of human intervention during the marshaling state 214 to switch the state handling for the respective autonomous vehicle(s) 110 to the de-boarding state 212. The next state transition step of the marshaling state 214 further comprises an instance wherein the infrastructure system 108 sends a trigger transitional message to the respective vehicle(s) 110 to initiate a start trigger associated with the off-boarding state 218. The next state transition step of the marshaling state 214 also comprises an instance wherein the infrastructure system 108 switches the state handling for the respective autonomous vehicle(s) 110 to the off-boarding state 218. For example, the autonomous vehicle(s) 110 reaches its destination and the routing sequence is complete and/or the autonomous vehicle(s) 110 is stationary when state handling for the respective autonomous vehicle(s) 110 is switched to the off-boarding state 218. In some examples, IMMs and VMMs are exchanged (e.g., the keep-alive mode) between the infrastructure system 108 and the autonomous vehicle(s) 110 in the instance when the autonomous vehicle(s) 110 is in a stationary mode.

The error state transition step of the marshaling state 214, in some examples, comprises an instance wherein the infrastructure system 108 sends a trigger transitional message to the respective autonomous vehicle(s) 110 to initiate a start trigger back to the on-boarding state 210. The error state transition step of the marshaling state 214 also comprises an instance wherein the infrastructure system 108 switches the state handling for the respective autonomous vehicle(s) 110 to the on-boarding state 210 when an error in the handshake protocol associated with the marshaling state 214 is detected and/or a destination and route sequence is undetermined. The error state transition step of the marshaling state 214 further comprises an instance wherein the infrastructure system 108 switches the state handling for the respective autonomous vehicle(s) 110 to the on-boarding state 210 when the wireless communication between the infrastructure system 108 and the autonomous vehicle(s) 110 is determined to be in a non-recoverable state. In some examples, the error state transition step of the marshaling state 214 can involve the infrastructure system 108 sending a trigger transitional message to the respective autonomous vehicle(s) 110 to transition into another state of the plurality of states upon a trigger of a temporary error and recovery state. For example, in the instance wherein the infrastructure system 108 identifies a change in the state of the autonomous vehicle 110 from VMMs, the infrastructure system 108 triggers the error state and instructs the autonomous vehicle(s) 110 to switch to another state of the plurality of states prior to the infrastructure system 108 taking control of the autonomous vehicle(s) 110.

The next state transition step of the de-boarding state 212, in some examples, comprises an instance wherein the infrastructure system 108 sends a trigger transitional message to the respective vehicle(s) 110 to initiate a start trigger associated with the on-boarding state 210. The next state transition step of the marshaling state 214 also comprises an instance wherein the infrastructure system 108 switches the state handling for the respective autonomous vehicle(s) 110 to the on-boarding state 210 when a wake-up sequence is completed with the autonomous vehicle(s) 110 (e.g., ignition-ON) and when any human intervention is completed. For example, in both instances of when the infrastructure system 108 switches the state handling for the respective autonomous vehicle(s) 110 to the on-boarding state 210, the autonomous vehicle(s) 110 send a request(s) for re-joining the infrastructure system 108 (e.g., via VMMs) in the last-known state (e.g., the de-boarding state 212). As a further example, when the autonomous vehicle(s) 110 re-join the marshaling and has returned to the geo-fenced ODD zone, the autonomous vehicle(s) 110 sends a VMM to the infrastructure system 108 with the last-known state (e.g., the de-boarding state 212).

The error state transition step of the on-boarding state 210, in some examples, comprises an instance wherein the infrastructure system 108 sends a trigger transitional message to the respective autonomous vehicle(s) 110 to initiate a start trigger to the on-boarding state 210. The error state transition step of the de-boarding state 212 also comprises an instance wherein the infrastructure system 108 switches the state handling for the respective vehicle(s) 110 to the on-boarding state 210 when a transient loss of wireless communication connectivity arises and/or a sign arises regarding a system error.

Regarding the off-boarding state 218, both the next state transition step and the error state transition step comprise both the infrastructure system 108 and the autonomous vehicle(s) 110 switching to the un-initiated state 218 upon reception of the off-boarding state 218 and/or upon completion of certain loop-process activities.

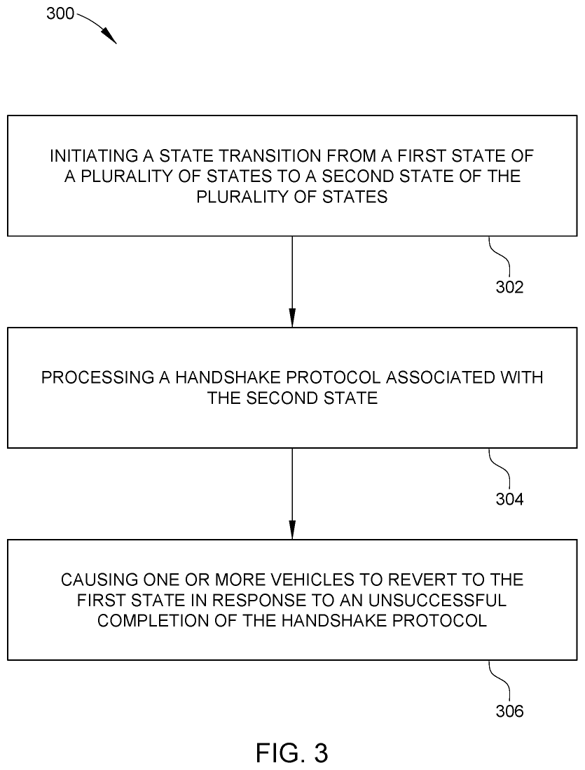

FIG. 3 is a flowchart illustrating an example method 300 for transitioning between feature states of an autonomous vehicle (e.g., the autonomous vehicle 110) in accordance with various implementations. At operation 302, a state transition from a first state of a plurality of states to a second state of the plurality of states is initiated at one or more vehicles. For example, the state transition from the first state to the second state is initiated based on a message uniquely associated with the second state. As another example, the message is received from an infrastructure system (e.g., the infrastructure system 108). As a further example, the plurality of states can include an un-initiated state (e.g., the un-initiated state 218), a pre-onboarding state (e.g., the pre-onboarding state 208), an onboarding state (e.g., the on-boarding state 210), a marshaling state (e.g., the marshaling state 214), a de-boarding state (e.g., the de-boarding state 212), and/or an off-boarding state (e.g., the off-boarding state 218). As yet another example, each state of the plurality of states is associated with a different message.

At operation 304, the one or more vehicles process a handshake protocol associated with the second state. For example, the handshake protocol associated with the second state is processed in response to the initiation of the state transition from the first state to the second state. As yet another example, an external handshake protocol can vary based on each of the plurality of states, such that one or more characteristics of the external handshake protocol can vary based on each of the plurality of states. As a further example, the one or more characteristics of the external handshake protocol can include an inter-transmit time associated with the message, a tolerance threshold of a connection strength associated with the one or more vehicles, or a combination thereof. As an additional example, processing the external handshake protocol can comprise the initiation of one or more actions based on a message exchange between the infrastructure system and the one or more vehicles. The one or more actions can include a verification of a wireless connection associated with the one or more vehicles, an authentication of the message, a validation of whether the one or more vehicles are within an operational design domain, or a combination thereof, for example. It is understood that the external handshake protocol may encompass each of the plurality of states such that each of the plurality of states may have different characteristic(s) (e.g., of the one or more characteristics) and/or initiate a different set of action(s) (e.g., of the one or more actions).

At operation 306, the one or more vehicles are caused to revert to the first state in response to an unsuccessful completion of the handshake protocol associated with the second state. For example, the reversion to the first state corresponds to one or more vehicles not transitioning from the first state to the second state unless the handshake protocol associated with the second state is successfully completed. In other words, the one or more vehicles are caused to remain in (e.g., revert to) the first state in response to the unsuccessful completion of the handshake protocol associated with the second state. In an example embodiment, the one or more vehicles are caused to progress to the second state (e.g., from the first state) based on a successful completion of the handshake protocol associated with the second state. In another example embodiment, a state transition from the second state of the plurality of states to a third state of the plurality of states is initiated at the one or more vehicles. For example, the state transition from the second state to the third state is initiated based on the progression to the second state and/or on a message uniquely associated with the third state. As another example, the one or more vehicles process a handshake protocol associated with the third state. As a further example, the handshake protocol associated with the third state is processed in response to the initiation of the state transition from the second state to the third state. As an additional example, the one or more vehicles are caused to progress to the third state in response to a successful completion of the handshake protocol associated with the third state. In an additional example embodiment, an alert is transmitted (e.g., by the one or more vehicles) to the infrastructure system. For example, the alert can be associated with the unsuccessful completion of the handshake protocol associated with the second state. As another example, the transmission of the alert is based on the reversion of the one or more vehicles to the first state.

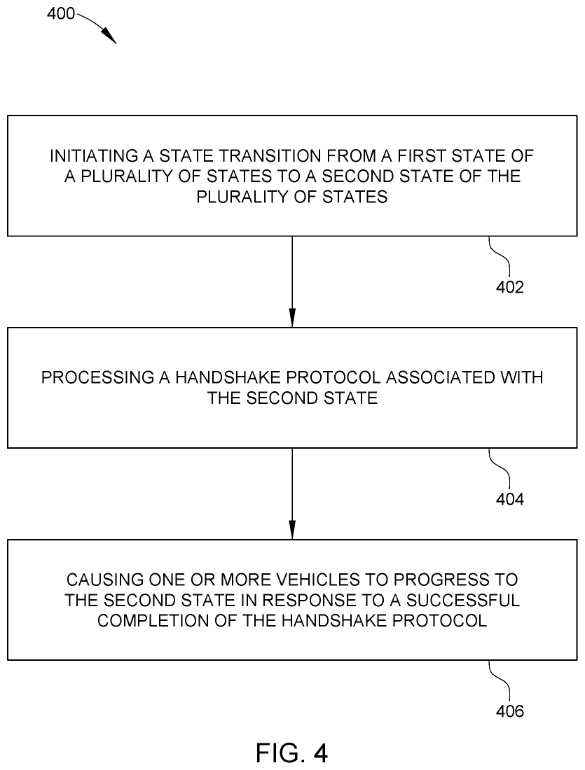

FIG. 4 is a flowchart illustrating an example method 400 for transitioning between feature states of an autonomous vehicle (e.g., the autonomous vehicle 110) in accordance with various implementations. At operation 402, a state transition from a first state of a plurality of states to a second state of the plurality of states is initiated at one or more vehicles. For example, the state transition from the first state to the second state is initiated based on a message uniquely associated with the second state. As another example, the message is received from an infrastructure system (e.g., the infrastructure system 108). As a further example, the plurality of states can include an un-initiated state (e.g., the un-initiated state 218), a pre-onboarding state (e.g., the pre-onboarding state 208), an onboarding state (e.g., the on-boarding state 210), a marshaling state (e.g., the marshaling state 214), a de-boarding state (e.g., the de-boarding state 212), and/or an off-boarding state (e.g., the off-boarding state 218). As yet another example, each state of the plurality of states is associated with a different message.

At operation 404, the one or more vehicles process a handshake protocol associated with the second state. For example, the handshake protocol associated with the second state is processed in response to the initiation of the state transition from the first state to the second state. As yet another example, an external handshake protocol can vary based on each of the plurality of states, such that one or more characteristics of the external handshake protocol can vary based on each of the plurality of states. As a further example, the one or more characteristics of the external handshake protocol can include an inter-transmit time associated with the message, a tolerance threshold of a connection strength associated with the one or more vehicles, or a combination thereof. As an additional example, processing the external handshake protocol can comprise the initiation of one or more actions based on a message exchange between the infrastructure system and the one or more vehicles. The one or more actions can include a verification of a wireless connection associated with the one or more vehicles, an authentication of the message, a validation of whether the one or more vehicles are within an operational design domain, or a combination thereof, for example.

It is understood that the external handshake protocol may encompass each of the plurality of states such that each of the plurality of states may have different characteristic(s) (e.g., of the one or more characteristics) and/or initiate a different set of action(s) (e.g., of the one or more actions).

At operation 406, the one or more vehicles are caused to progress to the second state in response to a successful completion of the handshake protocol associated with the second state. In an example embodiment, the one or more vehicles are caused to revert to the second state (e.g., from the first state), based on an unsuccessful completion of the handshake protocol associated with the second state. For example, the reversion to the first state corresponds to the one or more vehicles not transitioning from the first state to the second state unless the handshake protocol associated with the second state is successfully completed. In other words, the one or more vehicles are caused to remain in (e.g., revert to) the first state in response to the unsuccessful completion of the handshake protocol associated with the second state. In another example embodiment, a state transition from the second state of the plurality of states to a third state of the plurality of states is initiated at the one or more vehicles. For example, the state transition from the second state to the third state is initiated based on the progression to the second state and/or on a message uniquely associated with the third state. As another example, the one or more vehicles process a handshake protocol associated with the third state. As a further example, the handshake protocol associated with the third state is processed in response to the initiation of the state transition from the second state to the third state. As an additional example, the one or more vehicles are caused to progress to the third state in response to a successful completion of the handshake protocol associated with the third state.

Thus, one or more examples of the present disclosure provide a means for managing vehicle motion or movement control within a marshaling setting that can occur between a plurality of marshaling states to configure and validate that a relationship between an autonomous vehicle (e.g., the autonomous vehicle 110) and an infrastructure system (e.g., the infrastructure system 108) are operating properly, sufficiently authenticated, and are prepared to proceed to a next marshaling state or towards successful termination of the communication session.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method comprising:
initiating, at one or more vehicles, a state transition from a first state of a plurality of states to a second state of the plurality of states based on a message uniquely associated with the second state, wherein the message is received from an infrastructure system;
processing, by the one or more vehicles, a handshake protocol associated with the second state in response to the initiation of the state transition from the first state to the second state; and
causing the one or more vehicles to revert to the first state in response to an unsuccessful completion of the handshake protocol associated with the second state.

2. The method of claim 1, wherein the plurality of states includes an un-initiated state, a pre-onboarding state, an on-boarding state, a marshaling state, a de-boarding state, and an off-boarding state.

3. The method of claim 1, wherein an external handshake protocol varies based on each of the plurality of states such that one or more characteristics of the external handshake protocol varies based on each of the plurality of states, and wherein processing the external handshake protocol comprises:
initiating one or more actions based on a message exchange between the infrastructure system and the one or more vehicles, wherein the one or more actions includes a verification of a wireless connection associated with the one or more vehicles, an authentication of the message, a validation of whether the one or more vehicles are within an operational design domain, or a combination thereof, and wherein the one or more characteristics of the external handshake protocol includes an inter-transmit time associated with the message, a tolerance threshold of a connection strength associated with the one or more vehicles, or a combination thereof.

4. The method of claim 1, wherein each state of the plurality of states is associated with a different message.

5. The method of claim 1, further comprising:
causing the one or more vehicles to progress to the second state, from the first state, based on a successful completion of the handshake protocol associated with the second state.

6. The method of claim 5, further comprising:
initiating, at the one or more vehicles, a state transition from the second state of the plurality of states to a third state of the plurality of states based on the progression to the second state and on a message uniquely associated with the third state;
processing, by the one or more vehicles, a handshake protocol associated with the third state in response to the initiation of the state transition from the second state to the third state; and
causing, the one or more vehicles, to progress to the third state in response to a successful completion of the handshake protocol associated with the third state.

7. The method of claim 1, further comprising:
transmitting an alert to the infrastructure system associated with the unsuccessful completion of the handshake protocol associated with the second state, wherein the transmission of the alert is based on the reversion of the one or more vehicles to the first state.

8. A method comprising:
initiating, at one or more vehicles, a state transition from a first state of a plurality of states to a second state of the plurality of states based on a message uniquely associated with the second state, wherein the message is received from an infrastructure system;
processing, by the one or more vehicles, a handshake protocol associated with the second state in response to the initiation of the state transition from the first state to the second state; and
causing, the one or more vehicles, to progress to the second state in response to a successful completion of the handshake protocol associated with the second state.

9. The method of claim 8, wherein the plurality of states includes an un-initiated state, a pre-onboarding state, an on-boarding state, a marshaling state, a de-boarding state, and an off-boarding state.

10. The method of claim 8, wherein an external handshake protocol varies based on each of the plurality of states such that one or more characteristics of the external handshake protocol varies based on each of the plurality of states, and wherein processing the external handshake protocol comprises:
initiating one or more actions based on a message exchange between the infrastructure system and the one or more vehicles, wherein the one or more actions includes a verification of a wireless connection associated with the one or more vehicles, an authentication of the message, a validation of whether the one or more vehicles are within an operational design domain, or a combination thereof, and wherein the one or more characteristics of the external handshake protocol includes an inter-transmit time associated with the message, a tolerance threshold of a connection strength associated with the one or more vehicles, or a combination thereof.

11. The method of claim 8, wherein each state of the plurality of states is associated with a different message.

12. The method of claim 8, further comprising:
causing the one or more vehicles to revert to the second state, from the first state, based on an unsuccessful completion of the handshake protocol associated with the second state.

13. The method of claim 8, further comprising:
initiating, at the one or more vehicles, a state transition from the second state of the plurality of states to a third state of the plurality of states based on the progression to the second state and on a message uniquely associated with the third state;
processing, by the one or more vehicles, a handshake protocol associated with the third state in response to the initiation of the state transition from the second state to the third state; and
causing, the one or more vehicles, to progress to the third state in response to a successful completion of the handshake protocol associated with the third state.

14. A system comprising:
a vehicle system associated with one or more vehicles configured to:
initiate a state transition from a first state of a plurality of states to a second state of the plurality of states based on a message uniquely associated with the second state,
process a handshake protocol associated with the second state in response to the initiation of the state transition from the first state to the second state, and
cause the one or more vehicles to revert to the first state in response to an unsuccessful completion of the handshake protocol associated with the second state; and
an infrastructure system configured to:
send the message to the vehicle system.

15. The system of claim 14, wherein the plurality of states includes an un-initiated state, a pre-onboarding state, an on-boarding state, a marshaling state, a de-boarding state, and an off-boarding state.

16. The system of claim 14, wherein an external handshake protocol varies based on each of the plurality of states such that one or more characteristics of the external handshake protocol varies based on each of the plurality of states, and wherein the vehicle system, in association with processing the external handshake protocol, is further configured to:
initiate one or more actions based on a message exchange between the infrastructure system and the one or more vehicles, wherein the one or more actions includes a verification of a wireless connection associated with the one or more vehicles, an authentication of the message, a validation of whether the one or more vehicles are within an operation design domain, or a combination thereof, and wherein the one or more characteristics of the external handshake protocol includes an inter-transmit time associated with the message, a tolerance threshold of a connection strength associated with the one or more vehicles, or a combination thereof.

17. The system of claim 14, wherein each state of the plurality of states is associated with a different message.

18. The system of claim 14, wherein the vehicle system is further configured to:
cause the one or more vehicles to progress to the second state, from the first state, based on a successful completion of the handshake protocol associated with the second state.

19. The system of claim 18, wherein the vehicle system is further configured to:
initiate, at the one or more vehicles, a state transition from the second state of the plurality of states to a third state of the plurality of states based on the progression to the second state and on a message uniquely associated with the third state;
process, by the one or more vehicles, a handshake protocol associated with the third state in response to the initiation of the state transition from the second state to the third state; and
cause the one or more vehicles to progress to the third state in response to a successful completion of the handshake protocol associated with the third state.

20. The system of claim 14, wherein the vehicle system is further configured to:
transmit an alert to the infrastructure system associated with the unsuccessful completion of the handshake protocol associated with the second state, wherein the transmission of the alert is based on the reversion of the one or more vehicles to the first state.
